(19) United States
(12) Patent Application Publication
(10) Pub. No.: US 2006/0274162 A1
(43) Pub. Date: Dec. 7, 2006

(54) Image processing apparatus, liquid crystal display apparatus, and color correction method

(75) Inventor: Fumihiko Fujishiro, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/383,894

(22) Filed: May 17, 2006

(30) Foreign Application Priority Data
Jun. 1, 2005 (JP) 2005-161688
Mar. 24, 2006 (JP) 2006-082617

(51) Int. Cl. H04N 5/235

(52) U.S. Cl. 348/229.1

(57) ABSTRACT

An image processing apparatus has: a frame memory storing a signal of a previous image in a previous one frame, and a correction processing unit configured to receive signals of the previous image and a current image, correct a signal level of the current image based on a difference of signal levels between the previous and current images, execute the correction by applying a first correction mode where a relationship between the signal level of the previous image and an amount of correction of the signal level of the current image is common to three primary colors or a second correction mode for correcting the current image by applying another amount of correction so as to complete an optical response of liquid crystal in the entire primary colors within one frame display period when an input image transits from the previous image to the current image.

### CROSS REFERENCE TO RELATED APPLICATION

The present invention contains subject matter related to Japanese Patent Application No. 2005-161688 filed in the Japan Patent Office on Jun. 1, 2005 and Japanese Patent Application No. 2006-82617 filed in the Japan Patent Office on Mar. 24, 2006, the entire content of which being incorporated herein by reference.

### BACKGROUND OF THE INVENTION

1. Field of the Invention

The present invention relates to an image processing apparatus correcting, based on a difference of signal levels between a previous image in a previous one frame and a current image, a signal level of the current image in each objective color, a liquid crystal display apparatus and a color correction method.

2. Description of the Related Art

As a computer display device and a television receiving apparatus, a liquid crystal display device is in widespread use.

A response of liquid crystal of the liquid crystal display device sometimes may not follow enough an input voltage (a drive voltage) depending on a change pattern of the input voltage.

To overcome this, Japanese Patent Publication (B) No. 2616652 discloses a method temporarily applying a voltage corresponding a high signal level or a low signal level in switching an image signal to be input to the liquid crystal display device to thereby change acceleratingly an alignment of the liquid crystal, which is generally referred to as an “overdrive method”.

Japanese Patent Publication (A) No. 2002-62850 discloses a technology for holding in a table a level of correction voltage temporality applied, such as an amount of correction or an amount of overdrive.

### SUMMARY OF THE INVENTION

The above technology disclosed in the latter Patent Publication however may sometimes suffer from a disadvantage that, when a variation ratio of the signal level differs in each color, a specific color is apparent, in a pixel trio in three primary colors displaying a color mixed with two or three colors.

This is because a response characteristic of the liquid crystal. Namely, the liquid crystal has a characteristic that a movement thereof for changing a color from the black level to a low gray-scale (gradation) level is slower than that from the black level to a high gray-scale level, which results in a difference of the response rate. Therefore, a persistence of image (lag of image or after-image) where a specific color is apparent is caused.

An increase of the amount of overdrive (the amount of correction) for changing a color from the black level to a low gray-scale level in order to reduce a red persistence of image, for example usually causes an overshoot, thereby generating a noise component or losing a high grayscale impression. Otherwise a suppression of the amount of correction for changing a color from the black level to a high gray-scale level, for example a change to red component in a skin color such as pale yellow, causes a reduction of an overall response rate of the liquid crystal, so a general effect of the overdrive is not obtained.

It is desirable to prevent or suppress a generation of the persistence of image in a specified color in improving a response of a moving image by applying a so-called overdrive method.

According to an embodiment of the present invention, there is provided an image processing apparatus processing an image to be input to a liquid crystal display device, having: a frame memory storing a signal of a previous image in a previous one frame, and a correction processing unit configured to receive as input the signal of the previous image and a signal of a current image, and correct a signal level of the current image based on a difference of signal levels between the previous image and the current image, wherein the correction processing unit executes the correction by applying one of a first correction mode where a relationship between the signal level of the previous image and an amount of correction of the signal level of the current image is common to the respective colors of the three primary colors, and a second correction mode for correcting the current image in at least one of the three primary colors by applying a second amount of correction different from a first amount of correction of the first correction mode so as to complete an optical response of the liquid crystal display device in the entire primary colors within one frame display period upon an input image transiting from the previous image to the current image.

The correction processing unit according to an embodiment of the present invention may be modified to have, for each color of the three primary colors, an image conversion table configured to receive as input the signals of the previous image and the current image, specifying a corrected signal level of the current image by applying the first correction mode or the second correction mode to a pair of the signal levels of the input previous image and the input current image, and output the result.

The correction processing unit according to an embodiment of the present invention may be modified to have a color level comparison portion configured to receive as input the signals of the previous image and the current image, compare the signal levels of the input previous image and the input current image for each color of the three primary colors, and select one of the first correction mode and the second correction mode based on the comparison result.

In the above case, the correction processing unit according to an embodiment of the present invention may be modified to have a first image conversion table configured to convert for each color the current image, input in the first correction mode selected, to a current image with the signal level corrected based on a relationship of the signal level common to the three primary colors, and output the result, and a second image conversion table configured to convert for each color the current image, input in the second correction mode selected, to a current image with the signal level corrected by applying the second amount of correction in at least one of the three primary colors, and output the resultant.

Otherwise, the correction processing unit according to an embodiment of the present invention may be modified to have a first correction amount table configured to hold the first amount of correction for each color, receive as input the signal of the current image in the first correction mode selected, and output the first amount of correction corresponding to the signal level of the input current image; a difference correction amount table, as for at least one of the three primary colors, configured to hold for each color a difference between the first amount of correction and the second amount of correction, and output the difference of a color specified based on the comparison result of the color level comparison portion in the second correction mode selected; an adder-subtracter, as for at least one of the three primary colors, configured to add or subtract for each color the difference output from the difference correction amount table to or from the first amount of correction output from the first correction amount table, and output the second amount of correction; and an adder configured to receive as input the signal of the current image, add for each color the first amount of correction output from the first correction amount table or the second amount of correction output from the adder-subtracter to the input current image, and output the corrected signal of the current image.

Otherwise, the correction processing unit according to an embodiment of the present invention may be modified to have a first correction amount table configured to hold the first amount of correction for each color, receive as input the signal of the current image in the first correction mode selected, and output for each color the first amount of correction corresponding to the signal level of the input current image; a second correction amount table, as for at least one of the three primary colors, configured to hold for each color the second amount of correction, and output in each color the second amount of correction in the second correction mode selected; a switch configured to select one of the first correction amount table and the second correction amount table based on the comparison result of the color level comparison portion; and an adder configured to receive as input the signal of the current image, add for each color the first amount of correction or the second amount of correction input based on a selection result of the switch, and output the corrected signal of the current image.

The color level comparison portion according to an embodiment of the present invention may be modified to average in each color the signal levels of a plurality of pixels adjacent in units of a pixel trio of the three primary colors in the liquid crystal display device, and compare for each color the signal levels by applying the averaged signal level.

The correction processing unit according to an embodiment of the present invention may be modified to have a correction amount generation portion configured to hold intermittently part of each of the first amount of correction and the second amount of correction in a gray-scale range of an image, and generate by an interpolation an amount of correction un-held from the amount of correction held.

According to an embodiment of the present invention, there is provided a liquid crystal display apparatus having: a liquid crystal display device for displaying an image; a frame memory storing a signal of a previous image in a previous one frame; and a correction processing unit configured to receive as input the signal of the previous image and a signal of a current image, correct a signal level of the current image based on a difference of signal levels between the previous image and the current image, and output the corrected signal to the liquid crystal display device, wherein the correction processing unit executes the correction by applying one of a first correction mode where a relationship between the signal level of the previous image and an amount of correction of the signal level of the current image is common to the respective colors of the three primary colors, and a second correction mode for correcting the current image in at least one of the primary colors by applying a second amount of correction different from a first amount of correction of the first correction mode so as to complete an optical response of the liquid crystal display device in the entire primary colors within one frame display period upon an input image transiting from the previous image to the current image.

According to an embodiment of the present invention, there is provided a color correction method for executing a color correction of an image to be input, having the steps of: delaying the image to be input for each frame; and correcting, upon decision of an image portion transiting to the color to be corrected, determined in advance, in an image based on a difference of signal levels between a previous image to be input after delaying and an current image to be input without delaying, a color in the image portion transiting to the color to be corrected in the current image by switching a first correction mode where a relationship between a signal level of the previous image and a correction amount of a signal level of the current image is common to the respective colors of the three primary colors to a second correction mode applying in at least one of the primary colors a second amount of correction different from a first amount of correction of the first correction mode.

According to the above configuration, the correction processing unit for example executes a correction of a signal level (color correction) for each color of the three primary colors by applying the first correction mode or the second correction mode. In the first correction mode, the color correction is executed with a first amount of correction the same for the primary colors. In the second correction mode, the color correction is executed in at least one color with an amount of correction (second amount of correction) different from the amount of correction (first amount of correction) of other one or two colors.

According to the present invention, there are advantages that a generation of the persistence of image is prevented or suppressed in the specified color, in improving response of a moving image by applying the so-called overdrive method

### BRIEF DESCRIPTION OF THE DRAWINGS

The above and other features of embodiments of the present invention will be apparent in more detail with reference to the accompanying drawings, in which:

FIG. 1 is a block diagram illustrating an image processing apparatus according to a first embodiment of the present invention;

FIG. 2 is a block diagram illustrating an image processing apparatus according to a second embodiment;

FIG. 3 is a diagram illustrating a component of a first image conversion table;

FIG. 4 is a block diagram illustrating an image processing apparatus according to a third embodiment;

FIG. 5 is a block diagram illustrating an image processing apparatus according to a fourth embodiment;

FIG. 6 is a diagram illustrating a skin color distribution in a cross section of a color cylinder;

FIG. 7A is a diagram illustrating display properties after applying a first method, and FIG. 7B is a diagram illustrating display properties after applying a second method; and

FIG. 8 is a view illustrating an exemplary region of pixels to be averaged.

### DESCRIPTION OF THE PREFERRED EMBODIMENTS

Preferred embodiments according to the present invention will be described in more detail with reference to the drawings.

An image processing apparatus according to an embodiment of the present invention executes a correction processing of images to be input to a liquid crystal display device, by applying a signal of a previous image in a previous one frame and a signal of a current image to be corrected. The correction processing is defined as a processing for correcting a signal level of the current image for each color based on a difference of signal levels between the previous image and the current image. A liquid crystal display apparatus according to an embodiment of the present invention is provided with the liquid crystal display device and the respective component units of the above image processing apparatus configured to execute the correction of signal level (a color correction) for each color of the image to be input and output the corrected signal to the liquid crystal display device.

The correction processing includes a first correction mode and a second correction mode, and is executed with one of them.

The first correction mode is defined as a correction mode that a relationship between a signal level of previous image and an amount of correction of the signal level of current image is common to the respective colors in the three primary colors of red (R), green (G), and blue (B).

The second correction mode is defined as a correction mode for correcting a signal of the current image in at least one of RGB by applying a second amount of correction different from a first amount of correction of the first correction mode when the input image transits from the previous image to the current image preferably so as to complete an optical response of the liquid crystal within one frame display period in the entire color. Note that, in the first correction mode, the relationship is determined so as to complete the same within one frame display period in the entire color.

Hereinafter, exemplary embodiments of the image processing apparatus executable of the above correction processing will be described.

### First Embodiment

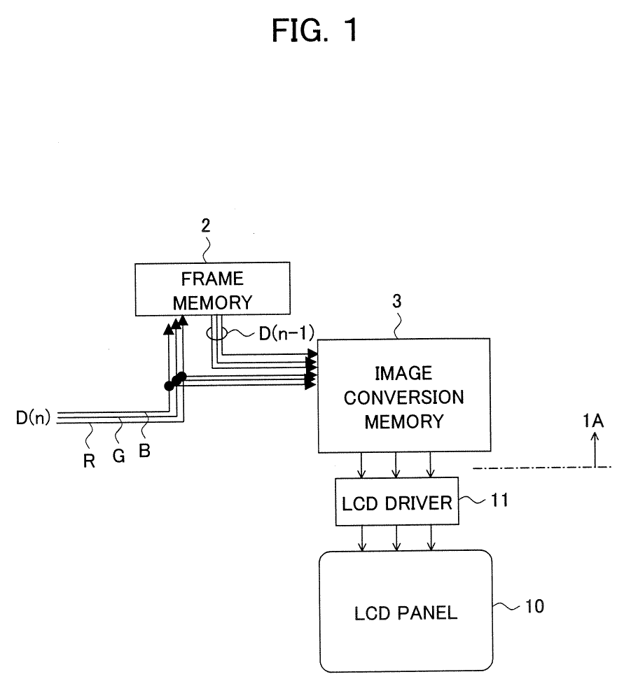

FIG. 1 illustrates a block diagram of an image processing apparatus of the first embodiment.

The image processing apparatus 1A of the first embodiment is provided with a frame memory 2 as a storage portion and an image substitution memory 3.

The frame memory 2 receives as input a current frame image data D(n) to be corrected, delays the same by one frame display period, and outputs the delayed image as a previous frame image data D(n-1).

The image conversion memory 3 can be realized by, omitted in the drawing, for example an image conversion table for the first correction mode (first image conversion table), an image conversion table for the second correction mode (second image conversion table), and a selection table for selecting one of the first image conversion table and the second image conversion table. The image conversion memory 3 may be provided with the image conversion tables for each color to be corrected for example a human skin color such as pale yellow.

The selection table is defined as a table prepared with a condition for selecting one of the first image conversion table, the second image conversion table, and other image conversion tables. The selection of the table will be executed based on the respective signal levels R(n), G(n), and B(n) in RGB of the current frame image data D(n) and the respective signal levels R(n-1), G(n-1), and B(n-1) in RGB of the previous frame image data D(n-1). And the selection of the table may be executed by a not shown CPU, or in a way that the selection table outputs an enable signal to any of the image conversion tables to be accessible. A mode switching portion is realized by the above configuration.

Specifically, when considered that there is almost no difference in each pair of red signal levels R(n) and R(n-1), green signal levels G(n) and G(n-1), and blue signal levels B(n) and B(n-1), the first image conversion table is selected.

When a change from a black level or other low signal levels to a signal level of the color to be corrected, for example the human skin color such as pale yellow in the present embodiment, is detected from the difference of signal levels in each RGB between the previous frame image and the current frame image, the second image conversion table for correcting the skin color is selected. If other color to be corrected exists, the other image conversion table for correcting the color may be selected in the same way.

The level of a signal in each RGB output from the second image conversion table is set to a value so that a desired color is displayed completely within one frame display period in the current frame image when the signal is input to a liquid crystal display (LCD) driver 11 to thereby drive an LCD panel (liquid crystal display device) 10.

Note that, the first image conversion table outputs a signal with a signal level common to the respective colors of RGB, so, in the same way as the overdrive method in the related art, the signal level is set to a value so that a desired color is displayed completely within one frame display period in the current frame image when the signal is input to the LCD driver 11 to thereby drive the LCD panel 10.

In the first embodiment, a selection of the first correction mode and the second correction mode is executed by the selection table.

Otherwise, in the following second to fourth embodiments, a color level comparator is provided for executing the selection function other than the table.

### Second Embodiment

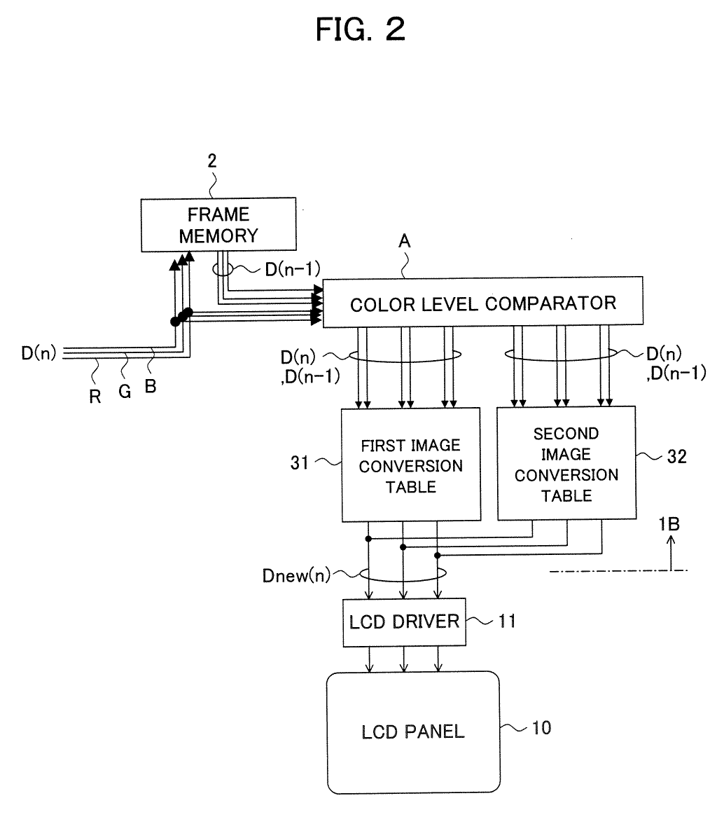

FIG. 2 is a block diagram of an image processing apparatus of the second embodiment.

An image processing apparatus 1B of the second embodiment is provided with the frame memory 2 and additionally a color level comparator 4 as a mode switch portion, a first image conversion table 31, and a second image conversion table 32.

The color level comparator 4 receives as input the previous frame image data D(n-1) and the current frame image data D(n) in units of the pixel trio of RGB, compares the signal levels of the previous frame image and the current frame image for each color, and detects whether or not an image transition is a change to the color to be corrected or that a possibility, where a change of the signal level of a color except for a specified color is delayed in the image transition to thereby cause the specified color to be emphasized, is included based on an amount of change of the signal level and a range of the signal level for each color. Further, based on the detected result, when the specified color is apparent immediately after the image transition, the comparator 4 outputs the current frame image data D(n) and the previous frame image data D(n-1) to the second image conversion table 32, otherwise, when it is not apparent, the comparator 4 outputs the same to the first image conversion table 31.

A luminance conversion (image data conversion) of the first correction mode is executed by the first image conversion table 31 in each color, otherwise the image data conversion of the second correction mode is executed by the second image conversion table 32. The converted current frame image data D_{new}(n) is output to the LCD driver 11, and the LCD panel 10 displays the image based on an output data (signal) from the LCD driver 11.

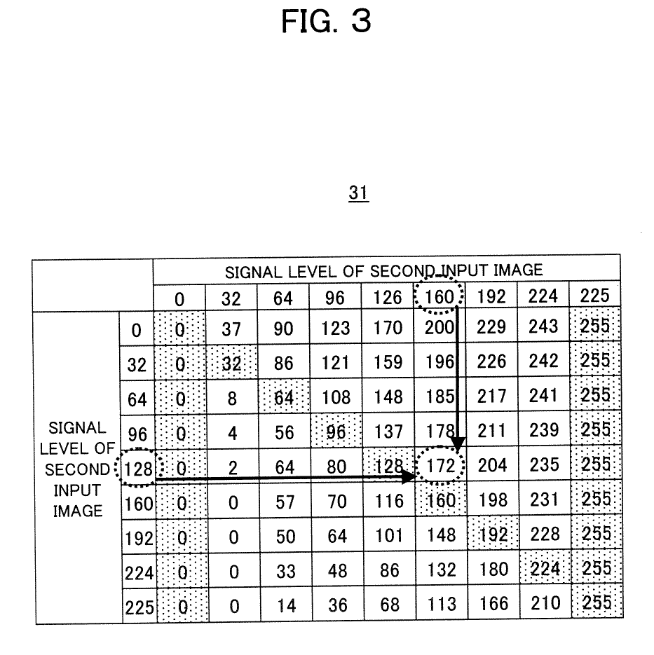

FIG. 3 illustrates a component of the first image conversion table 31.

In the drawing, an image (pixel) data signal in each RGB is assumed as a signal of 8 bits data, and the respective colors are displayed with 256 gray-scale (gradation) indicated by decimal number of 0 to 255.

In this case, a table for inputting 16 bits of data may be demanded for specifying a corrected gray-scale from a previous frame of 256 gray-scale and a current frame of 256 gray-scale, but a memory capacity thereof would be too large. So, on the assumption that the interpolation processing is executed, the pixel data with the gray scale reduced is stored in FIG. 3. Means for executing the interpolation processing, omitted in FIG. 2, is provided for example at an input side of the LCD driver 11 and may generate an entirely frame image by the interpolation processing. As an interpolation method, any of a straight-line interpolation, a three-point interpolation, and other linear interpolation, or a nonlinear interpolation is applied.

The first image conversion table 31 shown in FIG. 3, common to the respective colors of RGB, converts a signal level of the current frame to a value of the signal level lower than the signal level of the current frame when the signal level of the current frame is lower than a signal level of the previous frame, otherwise it converts the same to a value of the signal level higher than the signal level of the current frame when higher than the signal level of the previous frame.

In FIG. 3, for example when the signal level of the previous frame is assumed as “128” and the signal level of the current frame as “160”, a data of “172” is specified higher than the signal level of the current frame and output as the corrected signal level of the current frame. An amount of correction in this case (hereinafter, refereed to as a “first amount of correction”) becomes “12 (=172−160)”.

Note that, when the signal level of the previous frame is the minimum value of zero, the data of zero is held without depending on the signal level of the previous frame, otherwise, when the maximum value of “255”, the data of “255” is held.

The second image conversion table 32, omitted with details, is defined as a table that the first image conversion table 31 (FIG. 3) is corrected so that a specified color is not apparent in the entire combination in the gray scale. Hereinafter, a corrected amount of correction is referred to as a “second amount of correction” and a difference between the second amount of correction and the first amount of correction is referred to as a “difference amount of correction”.

### Third Embodiment

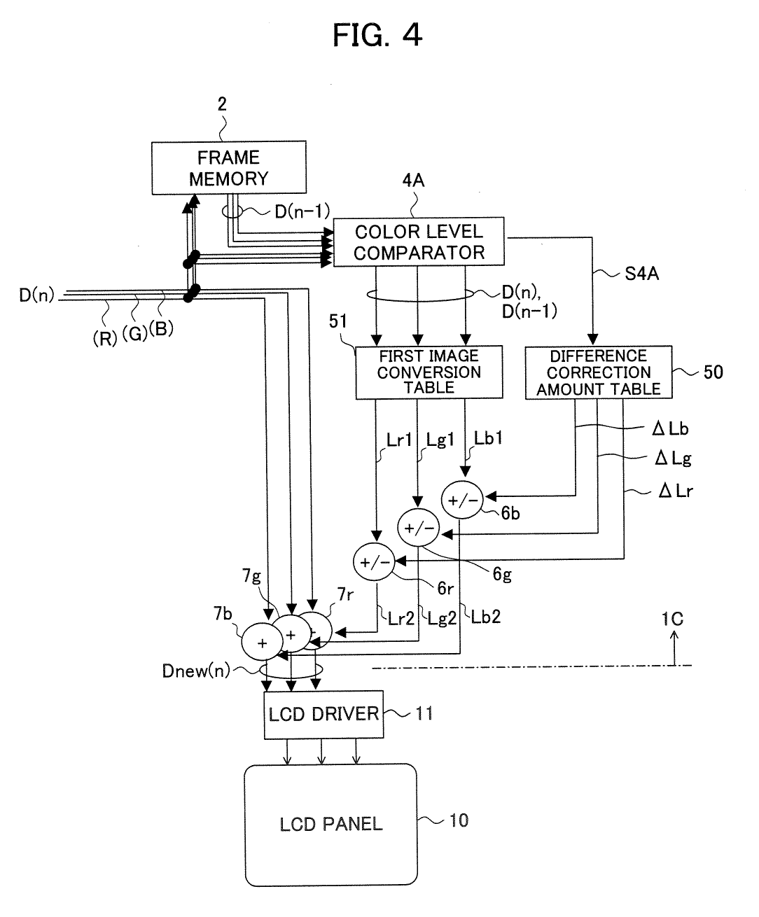

FIG. 4 is a block diagram of an image processing apparatus of the third embodiment.

An image processing apparatus 1C of the third embodiment is provided with the frame memory 2, a color level comparator 4A, and additionally a first correction amount table 51, a difference correction amount table 50, a red color (R) adder-subtracter 6r and a red color (R) adder 7r, a green color (G) adder-subtracter 6g and a green color (G) adder 7g, and a blue color (B) adder-subtracter 6b and a blue color (B) adder 7b.

The color level comparator 4A receives as input the previous frame image data D(n-1) and the current frame image data D(n) in units of the pixel trio of RGB, compares the signal levels between the previous frame image and the current frame image for each color, and detects whether or not a image transition includes the change to the color to be corrected or that a possibility, where a change of the signal level of a color except for a specified color is delayed in the image transition to thereby cause the specified color to be emphasized, is included based on an amount of change of the signal level and a range of the signal level for each color. Further, based on the detected result, when the specified color is apparent immediately after the image transition, the comparator 4A outputs a signal S4A including a difference information to the difference correction amount table 50, otherwise, when it is not apparent, the comparator 4 does not output the same. In each case, the color level comparator 4A outputs the current frame image data D(n) and the previous frame image data D(n-1) to the first image conversion table 51.

The first image conversion table 51 specifies an amount of correction in the first correction mode (first amount of correction) common to each color of RGB, based on the signal levels of the input previous frame image data D(n-1) and the input current frame image data D(n) for each color, and outputs the same. Namely, from the first correction amount table 51, a first amount of red color (R) correction Lr1, a first amount of green color (G) correction Lg1, and a first amount of blue color (B) correction Lb1 are respectively output to the R adder-subtracter 6r, the G adder-subtracter 6g, and the B adder-subtracter 6b.

In a first correction mode, an adjustment of the amount of correction (add-subtract of the difference amount of correction) for the specified color being unclear is unnecessary, so the first amount of R correction Lr1, the first amount of G correction Lg1, and the first amount of B correction Lb1 pass through the adder-subtracters 6r, 6g, and 6b, and are input to the R adder 7r, the G adder 7g, and the B adder 7b.

Otherwise, in a second correction mode, the signal S4A including the difference information is input to the difference correction amount table 50, which specifies the difference amount of correction for each color based on the signal S4A including the difference information and outputs the resultant. Namely, from the difference correction amount table 50, a difference amount of red color (R) correction ΔLr, a difference amount of green color (G) correction ΔLg, and a difference amount of blue color (B) correction ΔLb are output to the R adder-subtracter 6r, the G adder-subtracter 6g, and the B adder-subtracter 6b.

In the R adder-subtracter 6r, the difference amount of R correction ΔLr is added to or subtracted from the first amount of R correction Lr1, and the resultant is input as a second amount of R correction Lr2 to the R adder 7r. In the same way as the above, in the G adder-subtracter 6g, the difference amount of G correction ΔLg is added to or subtracted from the first amount of G correction Lg1, and the resultant is input as a second amount of G correction Lg2 to the G adder 7g. Further, in the B adder-subtracter 6b, the difference amount of B correction ΔLb is added to or subtracted from the first amount of B correction Lb1, and the resultant is input as a second amount of B correction Lb2 to the B adder 7b. A control information whether the respective adder-subtracters execute an addition processing or a subtraction processing may be included in the difference amount of correction to be input or separately received as input from the color level comparator 4A.

The current frame image data D(n) in the respective colors are input to the adders 7r, 7g, and 7b, added to the second amounts of correction Lr2, Lg2, and Lb2, thereby being converted to new current frame image data D_{new}(n).

The converted current frame image data D_{new}(n) are output to the LCD drive 11, and the image is displayed on the LCD panel 10 based on an output form the LCD driver 11.

### Fourth Embodiment

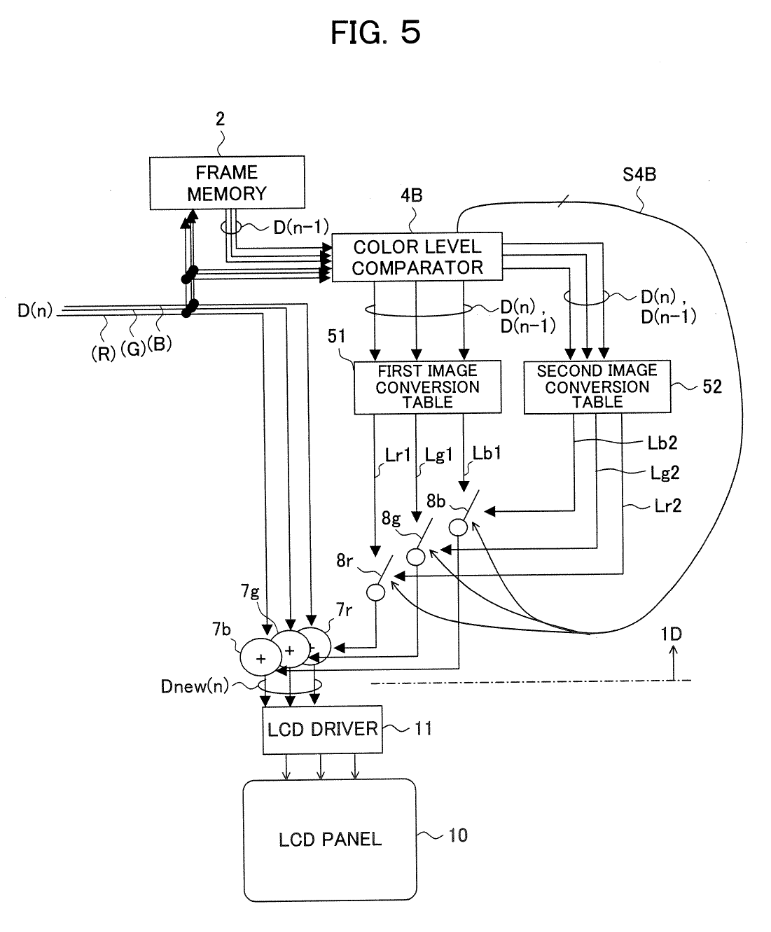

FIG. 5 illustrates a block diagram of an image processing apparatus of the fourth embodiment.

The fourth embodiment is the same way as the third embodiment in that the amount of correction is added to the current frame image data D(n) as the basic operation, but differs from the third embodiment in a way of generating the amount of correction. Namely, in the fourth embodiment, the second amount of correction is generated not by addition or subtraction of the difference amount of correction but by tables, which hold the resultant. And the first amount of correction and the second amount of correction are switched with a switch.

As a configuration for executing the above, an image processing apparatus ID shown in FIG. 5 is provided with a second correction amount table in place of the difference correction amount table 50 shown in FIG. 4, and switches 8r, 8g, and 8b for each color as the mode switching portions in place of the adder-subtracters 6r, 6g, and 6b shown in FIG. 4.

A color level comparator 4B of the present embodiment is the same in the basic operation as the color level comparator 4A shown in FIG. 4, and differs in that a switching signal S4B for controlling the switches 8r, 8g, and 8b for each color is output and that the current frame image data D(n) and the previous frame image data D(n-1) in RGB are output to the second correction amount table 52.

The second correction amount table 52 specifies for each color an amount of correction in the second correction mode, common to the respective colors of RGB, based on the signal levels of the input current frame image data D(n) and the input previous frame image data D(n-1) for each color, and outputs the resultant. Namely, from the second correction amount table 52, the second amount of R correction Lr2, the second amount of G correction Lg2, and the second amount of B correction Lb2 are respectively output to the red color (R) switch 8r, the green color (G) switch 8g, and the blue color (B) switch 8b.

Each of those switches 8r, 8g, and 8b controls whether the first amount of correction or the second amount of correction is output separately in RGB. Therefore, the amounts of correction output through the switches are added by the adders 7r to 7b to the respective color data of the current frame image data D(n) to thereby generate new current frame image data D_{new}(n) for each color, and the image is displayed with the new current frame image data D_{new}(n). As a result, the specified color is corrected so that the persistence of image is unclear, otherwise other colors are corrected by adjusting a hue of the entire pixel trio so as to differ little from a desired color if necessary.

Blow, a processing example applied with the color level comparator and an example of a specific value of the first amount of correction, the second amount of correction, and the difference amount of correction will be described with reference to a correction of the skin color in transition of a display image from the black level to the skin color.

Processing example of color level comparator

In the color level comparators 4 (FIG. 2), 4A (FIG. 4), 4B (FIG. 5), a previous frame (n-1) data (previous frame image data D(n-1)) previous to a current frame (n) to be corrected and a current frame (n) data (current frame image data D(n)) are compared for each RGB pixel trio, which may sometimes thinned down.

Based on the comparison result, a decision whether or not the previous frame (n-1) data is the black level is performed.

As an example of a condition for the above decision, when the entire pixel data for each RGB is included in a lower range of 256 gray-scale of 0 to 255, for example, in 0 to 32, it is decided whether or not the current frame (n) data in the pixel trio is included in the black level.

And a decision whether or not the current frame (n) data is included in the skin color such as pale yellow or a color range near the skin color is formed. Below, two examples of conditions for the decision will be explained.

In a first example of the condition, the skin color or the color range including the skin color is specified from a difference of signal levels in any two or three colors or from its combinations in the current frame (n) data. When a standard value of the skin color in 256 gray-scale is for example assumed as (R, G, B)=(250, 200, 96), the color range including the skin color is detected by whether or not a difference (R−B) between the maximum signal level R and the minimum signal level B is included in a range of about 150 to 60. Further when the range of color to be detected is limited to the skin color, the above color difference (R−B) is combined with other color differences (R−G) and/or (G−B) to thereby limit the range of color including the skin color.

In a second condition example, an HSV (hew, saturation, and value) conversion is applied, preferably applied in detecting the skin color more accurately. The RGB data is subjected to the HSV conversion, thereby enabling a decision of the skin color relatively easily.

In the HSV conversion, a color cylinder similar to Munsell color solid is extracted from the RGB data and applied.

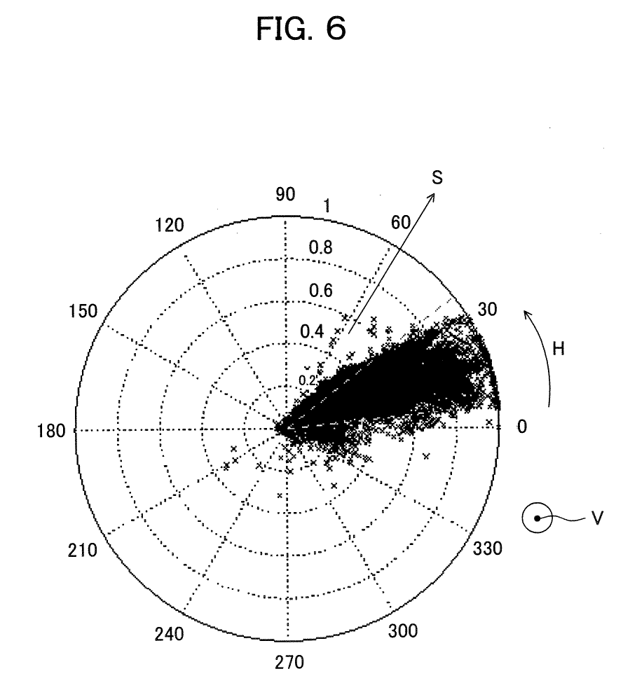

FIG. 6 illustrates a distribution of the skin color in a section of the color cylinder.

In the drawing, each color data in RGB is standardized in a range of 0 to 1, the value V is 0 to 1, the hue H is 0 to 360 degree, and the saturation S is 0 to 1. Note that, although the scales of the hue H and the saturation S are illustrated as the drawing, the value V has a scale vertical to a sheet, so the distributed points of the value V is overlapped and indicated without concerning its vertical direction value.

By applying the each color data (R, G. B), the value V and the saturation S are expressed by the following formulas (1-1) and (1-2) and the hue H is expressed by the following formulas (2-1) to (2-3). The condition of the hue H is set to 6≦H≦38 in this case, the skin color could be designated.

(Formula 1)
V=ₘₐₓ(R, G, B) (1-1)
S=(V−X)/V (1-2)

Where, X=ₘᵢₙ(R, G, B).

(Formula 2)
H=(pi/3)×(b−g) when R=V (2-1)
H=(pi/3)×(2+r−b) when G=V (2-2)
H=(pi/3)×(4+g−r) when B=V (2-3)

Where, r=(V−R)/(V−X),
g=(V−G)/(V−X), and
b=(V−B)/(V−X).

When that the current frame (n) data being included in the skin color or the color range near the skin color designated by applying the above methods is decided and the previous frame (n-1) data is included in the black level, the respective color level comparators 4, 4A, and 4B select the second correction mode, otherwise the comparators select the first correction mode.

Calculation example of amount of overdrive (amount of correction)

Below, a calculation example of the amount of correction (second amount of correction) applied in preparing the second correction amount table 52 shown in FIG. 5 will be explained.

The previous frame (n-1) pixel data is assumed as zero for each RGB color and the current frame (n) pixel data is assumes as R of 192, G of 160, and B of 64. In this case, the respective first amounts of correction in RGB become Lr1 of +37 (=229−192), Lg1 of +40 (=200−160), and Lb1 of +26 (=90−64). And the respective difference amounts of correction ΔLr, ΔLg, and ΔLb for RGB are for example prepared by the following method under a condition where a transition time of the signal level in the liquid crystal display panel is within one frame display period when an image is displayed with the corrected RGB data.

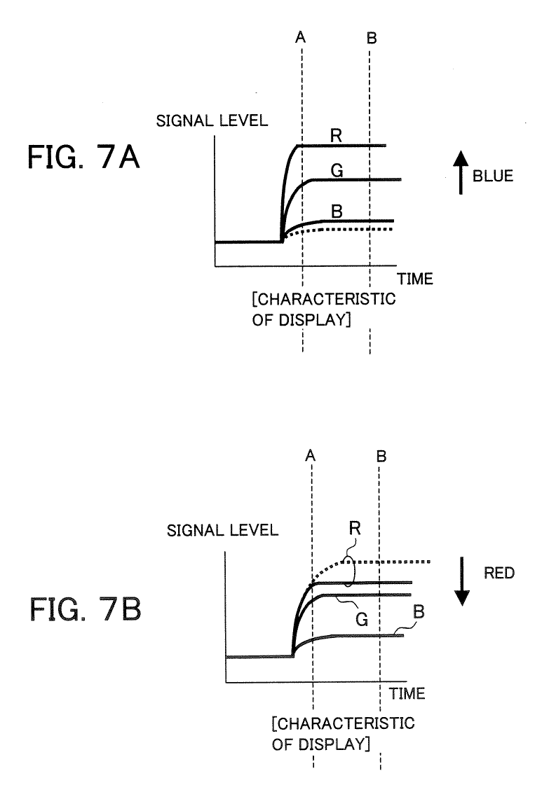

In a first method, as shown in FIG. 7A, the amount of overdrive (first amount of correction) in blue color having a longest response time is increased.

The difference amount of correction ΔLb being the amount to be increased is prepared by a predetermined formula, for example (R−B)/b, where b is suitable integer of two or more. When the formula is applied for example with b of 4 assumed, R of 192 and B of 64 are given, and then the difference amount of B correction ΔLb=(192−64)/4=+32 stands. In FIG. 4, the resultant of “32” is added to the first amount of R correction Lr1 of +26 by the B adder-subtracter 6b. Therefore, the second amount of B correction Lb2 becomes 58 (=26+32).

Consequently, an optical response of the liquid crystal is improved in the B pixel of the pixel trio, so the amount of the red component is relatively reduced, as a result the red persistence of image is not apparent. In this case, for a color balance of the skin color such as pale yellow, the difference amounts of correction ΔLg and ΔLb of green and red may be set to certain plus values by applying suitable other formulas.

The difference amount of B correction ΔLb is prepared, in the same way, in colors other than the color of R=192, G=160, and B=64 in FIG. 3, and the difference amounts of R and G correction are also prepared if necessary. In this case, the value of b could be properly changed. Note that, when the value of the formula (R−B)/b becomes negative, it is fixed to zero.

Therefore, a formation of the difference correction amount table 50 shown in FIG. 4 is completed. The second correction amount table 52 shown in FIG. 5 is prepared by adding the first amount of correction to the prepared difference amount of correction.

In a second method, as shown in FIG. 7B, in contrast to the first method, the amount of overdrive for red of apparent color is reduced.

The difference amount of R correction ΔLr is prepared by a predetermined formula, for example (R−B)/b, where b is suitable integer of two or more. In the second method, by the R adder-subtracter 6r shown in FIG. 4, the difference amount of R correction ΔLr is subtracted from the first amount of R correction Lr1.

Note that, in the same way as the first method, in consideration of a color balance, other difference amounts of correction such as ΔLg and ΔLb may be set to certain values, which are subtracted from the respective first amounts of correction. In the blue pixel having most lowest response, under a condition of the optical response of the liquid crystal being completed within the one frame display period, if the condition is not fulfilled, the difference amount of correction may be set to zero not to change the first amount of correction, otherwise the difference amount of correction may be added to the first amount of correction.

A third method is applied by combining the first method with the second method.

Due to the control of the amount of overdrive based on the color information detection, in an image information in the skin color displayed frequently in a television image, the red persistence of image generated in movement of an image including for example a human skin color such as pale yellow can be reduced.

Specifically, in increasing the amount of overdrive for blue, the amount of overdrive increases only if necessary, namely if the red persistence of image is reducible (the second correction mode), otherwise in other cases the overdrive control in the related art is applied (the first correction mode). As a result, an image quality is improved.

In reducing the amount of overdrive for red, the amount of overdrive is reduced only if necessary, namely if the red persistence of image is reducible (the second correction mode), otherwise in other cases the overdrive control in the related art is applied (the first correction mode). As a result, an image quality is improved.

In the above description, the entire processing shown in FIG. 1 to FIG. 5, such as a color level comparison, a calculation of the first and second amounts of correction, a calculation of the difference amount of correction, an addition and subtraction for calculating the second amount of correction, and an addition and subtraction for generating a new pixel data, is executed in units of the pixel trio of the three primary colors.

Note that, the unit is preferably a pixel data of the respective colors of the three primary colors, averaged in a region including a plurality of pixel trios positioned around a pixel trio to be corrected.

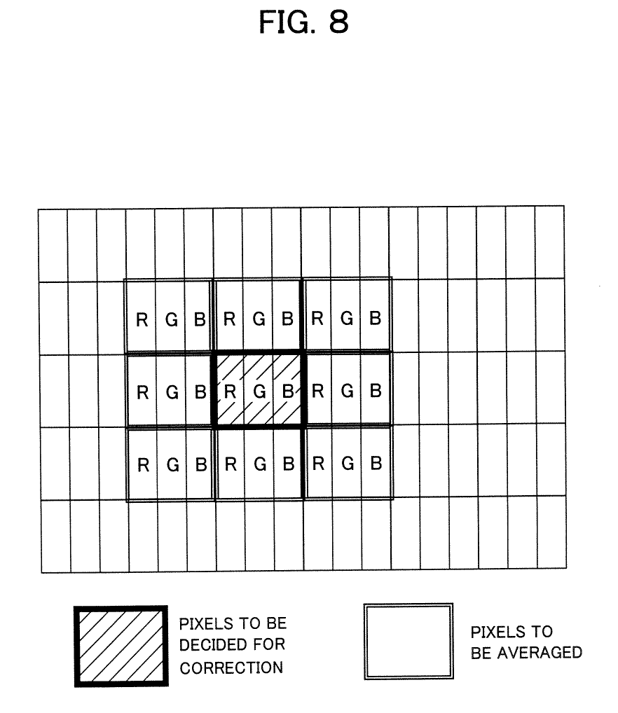

FIG. 8 illustrates a region of 3×3 of the pixel trios defined as a region of pixels to be averaged. The averaging processing is executed by a not shown CPU in advance.

In the above way, the pixel data with the respective colors of RGB averaged is applied to a decision of the skin color, so a noise component can be suppressed and misdetection can be prevented. As a result, an advantage can be obtained in that a detection accuracy of the skin color is improved.

It should be understood by those skilled in the art that various modifications, combinations, sub-combinations and alterations may occur depending on design requirements and other factors in so far as they are within scope of the appended claims or the equivalents thereof.

What is claimed is:

1. An image processing apparatus processing an image to be input to a liquid crystal display device, comprising:
a frame memory storing a signal of a previous image in a previous one frame, and
a correction processing unit configured to receive as input the signal of the previous image and a signal of a current image, and correct a signal level of the current image based on a difference of signal levels between the previous image and the current image,
wherein the correction processing unit executes the correction by applying one of
a first correction mode where a relationship between the signal level of the previous image and an amount of correction of the signal level of the current image is common to the respective colors of the three primary colors, and
a second correction mode for correcting the current image in at least one of the three primary colors by applying a second amount of correction different from a first amount of correction of the first correction mode so as to complete an optical response of the liquid crystal display device in the entire primary colors within one frame display period upon an input image transiting from the previous image to the current image.

2. An image processing apparatus as set forth in claim 1, wherein the correction processing unit comprises, for each color of the three primary colors, an image conversion table configured to receive as input the signals of the previous image and the current image, specifying a corrected signal level of the current image by applying the first correction mode or the second correction mode to a pair of the signal levels of the input previous image and the input current image, and output the result.

3. An image processing apparatus as set forth in claim 1, wherein the correction processing unit comprises a color level comparison portion configured to receive as input the signals of the previous image and the current image, compare the signal levels of the input previous image and the input current image for each color of the three primary colors, and select one of the first correction mode and the second correction mode based on the comparison result.

4. An image processing apparatus as set forth in claim 3, wherein the correction processing unit further comprises
a first image conversion table configured to convert for each color the current image, input in the first correction mode selected, to a current image with the signal level corrected based on a relationship of the signal level common to the three primary colors, and output the result, and
a second image conversion table configured to convert for each color the current image, input in the second correction mode selected, to a current image with the signal level corrected by applying the second amount of correction in at least one of the three primary colors, and output the resultant.

5. An image processing unit as set forth in claim 3, wherein the correction processing unit comprises
a first correction amount table configured to hold the first amount of correction for each color, receive as input the signal of the current image in the first correction mode selected, and output the first amount of correction corresponding to the signal level of the input current image for each color;
a difference correction amount table, as for at least one of the three primary colors, configured to hold for each color a difference between the first amount of correction and the second amount of correction, and output the difference of a color specified based on the comparison result of the color level comparison portion in the second correction mode selected;
an adder-subtracter, as for at least one of the three primary colors, configured to add or subtract for each color the difference output from the difference correction amount table to or from the first amount of correction output from the first correction amount table, and output the second amount of correction; and
an adder configured to receive as input the signal of the current image, add for each color the first amount of correction output from the first correction amount table or the second amount of correction output from the adder-subtracter to the signal of the input current image, and output the corrected signal of the current image.

6. An image processing apparatus as set forth in claim 3, wherein the correction processing unit comprises
a first correction amount table configured to hold the first amount of correction for each color, receive as input the signal of the current image in the first correction mode selected, and output for each color the first amount of correction corresponding to the signal level of the input current image;
a second correction amount table, as for at least one of the three primary colors, configured to hold for each color the second amount of correction, and output for each color the second amount of correction in the second correction mode selected;
a switch configured to select one of the first correction amount table and the second correction amount table based on the comparison result of the color level comparison portion; and
an adder configured to receive as input the signal of the current image, add for each color the first amount of correction or the second amount of correction input based on a selection result of the switch, and output the corrected signal of the current image.

7. An image processing apparatus as set forth in claim 3, wherein the color level comparison portion averages for each color the signal levels of a plurality of pixels adjacent in units of a pixel trio of the three primary colors in the liquid crystal display device, and compares for each color the signal levels by applying the averaged signal level.

8. An image processing apparatus as set forth in claim 1, wherein the correction processing unit comprises a correction amount generation portion configured to hold intermittently part of each of the first amount of correction and the second amount of correction in a gray-scale range of an image, and generate by an interpolation an amount of correction un-held from the amount of correction held.

9. A liquid crystal display apparatus comprising:
a liquid crystal display device for displaying an image;
a frame memory storing a signal of a previous image in a previous one frame; and
a correction processing unit configured to receive as input the signal of the previous image and a signal of a current image, correct a signal level of the current image based on a difference of signal levels between the previous image and the current image, and output the corrected signal to the liquid crystal display device,
wherein the correction processing unit executes the correction by applying one of
a first correction mode where a relationship between the signal level of the previous image and an amount of correction of the signal level of the current image is common to the respective colors of the three primary colors, and
a second correction mode for correcting the current image in at least one of the three primary colors by applying a second amount of correction different from a first amount of correction of the first correction mode so as to complete an optical response of the liquid crystal display device in the entire primary colors within one frame display period upon an input image transiting from the previous image to the current image.

10. A liquid crystal display apparatus as set forth in claim 9, wherein the correction processing unit comprises an image conversion table configured to receive as input the signals of the previous image and the current image, specify a corrected signal level of the current image by applying the first correction mode or the second correction mode to a pair of the signal levels of the input previous image and the input current image, and output the result for each color of the three primary colors.

11. A liquid crystal display apparatus as set forth in claim 9, wherein the correction processing unit comprises a color level comparison portion configured to receive as input the signals of the previous image and the current image, compare, for each color of the three primary colors, the signal levels of the input previous image and the input current image, and select one of the first correction mode and the second correction mode based on the comparison result.

12. A color correction method for executing a color correction of an image to be input, comprising the steps of:
delaying the image to be input for each frame, and
correcting, upon decision of an image portion transiting to the color to be corrected, determined in advance, in an image based on a difference of signal levels between a previous image to be input after delaying and an current image to be input without delaying, a color in the image portion transiting to the color to be corrected in the current image by switching a first correction mode where a relationship between a signal level of the previous image and a correction amount of a signal level of the current image is common to the respective colors of the three primary colors to a second correction mode applying in at least one of the three primary colors a second amount of correction different from a first amount of correction of the first correction mode.
